(19) United States
(12) Patent Application Publication
(10) Pub. No.: US 2007/0298635 A1
(43) Pub. Date: Dec. 27, 2007

(54) Variable length dummy card

(75) Inventor: Ching-Hsiang Chiu, Taipei Hsien (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 11/700,020

(22) Filed: Jan. 31, 2007

(30) Foreign Application Priority Data
Jun. 22, 2006 (TW) 95210953

(51) Int. Cl. H01R 13/44

(52) U.S. Cl. 439/148

(57) ABSTRACT

A variable length dummy card includes a fixed component and a moveable component. The fixed component includes a first sliding part. A second sliding part is arranged on the moveable component corresponding to the first sliding part. Therefore, the moveable component slides on the fixed component and changes the length of the dummy card.

### BACKGROUND

The present application is based on, and claims priority from, Taiwan Application Serial Number 95210953, filed Jun. 22, 2006, the disclosure of which is hereby incorporated by reference herein in its entirety.

### FIELD OF INVENTION

The present invention relates to a dummy card. More particularly, the present invention relates to a variable length dummy card.

### DESCRIPTION OF RELATED ART

Digital products are becoming smaller and more compact. For example, in recent years notebooks, cellular phones, PDAs (Personal Digital Assistants), or PMPs (Portable Media Players) have become significantly smaller. The object of these smaller electronic devices is to enable users to enjoy the digital information and work anywhere. Therefore, these digital products must be able to perform with the same functions expected of larger, equivalent devices but in devices with smaller volumes and available space. Even though devices are smaller they should especially have powerful processing units for processing information speedily.

All digital products now have expansion slots. The various expansion slots have many categories of corresponding interface cards or memory to increase the function of the digital products and enhance the data performance. For example, the PCMCIA (Personal Computer Memory Card International Association) card is the most popular expansion card for notebooks. The PCMICA card can be designed as a sound card, an HDD, or an Ethernet card to increase the function of the notebooks. Smaller expansion cards such as SD (Secure Digital) cards, and CF (Compact Flash) cards are usually used to increase the storage capacity of the PDA. Although most portable electronic devices now have at least one expansion slot, the expansion cards are usually optional. The electronic device manufacturer will therefore insert a dummy card in the slot to prevent particles or foreign matter from entering and damaging the slot.

Increased competition in the electronics industry has made aesthetic appeal a differential advantage. This implies the overall appearance of the electronic device must be able to attract potential customers. Therefore, when designing electronic devices, the appearance of the new device is important. The implications for the development and design of the dummy card means that different devices with different expansion slot sizes require unique dummy cards. Designing unique dummy cards for each devices wastes resources and design time.

To protect the slot, some design replaces the dummy card with a cover. However, the cover design is more complex than the dummy card, and wastes space and components. The balance of the cost and the space is difficult to achieve.

Therefore, to save resources and time spent of developing dummy cards for each product or to save resources spent on developing complex dummy card slot covers, a new dummy that can be used in a wide range of electronic devices regardless of the size of the expansion card slot must be provided.

### SUMMARY

A length changeable dummy card comprises a main body, and a moveable component. The main body includes a first sliding part. The moveable component is arranged on the side of the main body. The moveable component has a second sliding part corresponding to the first sliding part of the main body. Therefore, the moveable component can slide on the main body, and change the length of the dummy card.

It is to be understood that both the foregoing general description and the following detailed description are examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1A is a schematic diagram of the embodiment of the present invention when it is configured with its shortest length;

FIG. 1B is a schematic diagram of the embodiment of the present invention when it is configured with its longest length;

FIG. 2A is a schematic diagram of a decomposition view of the embodiment of the present invention;

FIG. 2B is a schematic diagram of an enlarged view of the first sliding block of the embodiment of the present invention;

FIG. 2C is a schematic diagram of an enlarged view of the protrusion of the embodiment of the present invention; and

FIG. 3 is a schematic diagram of a bottom decomposition view of the embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The following provides a detailed description of embodiments of the invention. The dummy card has two components, a main body and a moveable component 104. The length of the dummy card can be changed by the cooperation of the engagement member and the sliding part. The dummy card of the embodiment of the present invention is designed for the PCMCIA slot. Someone skilled in the art could change the structure and size to satisfy other slots such as SD card slots or CF card slots.

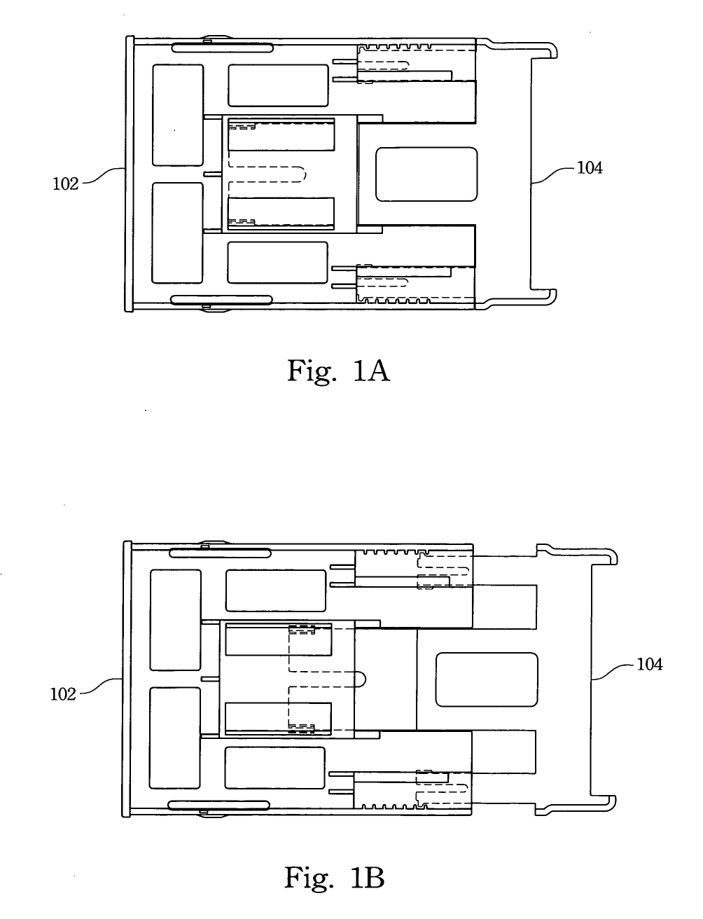

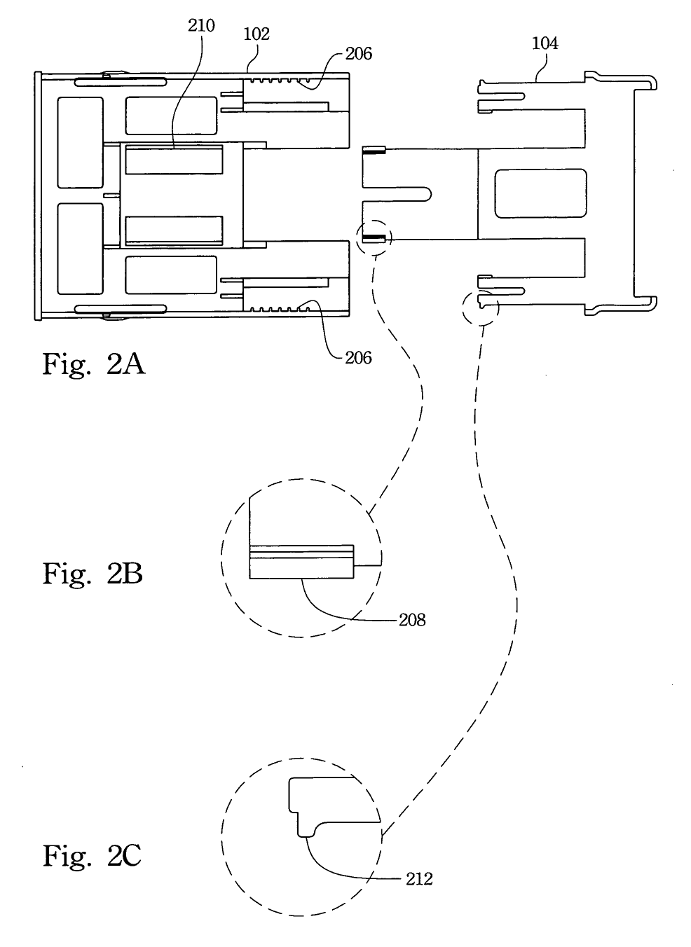

FIG. 1A and FIG. 1B are a top view of the dummy card of the embodiment. FIG. 1A is a diagram of the dummy card when it is configured with its shortest length. FIG. 1B is a diagram of the dummy card when it is configured with its longest length. The dummy card comprises a main body 102 and a moveable component 104. The cooperation between these two components 102 and 104 determines the length of the dummy card. The dummy card overcomes the variable sizes of the digital devices by having a variable length. For a detailed description of the changing the length of the dummy card please refer to FIG. 2A and FIG. 2B.

FIG. 2A is a decomposition view of the dummy card of the present embodiment. The main body 102 is a fixed component. The moveable component 104 is arranged on a side of the main body 102. The main body 102 includes a first sliding part and a first engagement member. The first sliding part is a first sliding rail 210 in the embodiment. The first engagement member is a rack structure 206 in the embodiment. The moveable component 104 has a second sliding part arranged thereon. In this embodiment, the second sliding part is a first sliding block 208.

FIG. 2B is an enlarged view of the first sliding block 208. The first sliding block 208 is arranged on the moveable component 104 corresponding to the first sliding rail 210 of the main body 102. The moveable component 102 further comprises a second engagement member arranged corresponding to the rack structure of the fixed component 102. The second engagement member is a protrusion 212 in the embodiment. FIG. 2C is an enlarged view of the protrusion 212 of the embodiment.

The first sliding rail 210 of the fixed component 102 has a fixed length and no opening in the two extremities. The first sliding block 208 of the moveable component 104 slides in the first sliding rail 210. Due to there being no opening in the two extremities of the first sliding rail 210, the moveable component 104 can not be separated from the main body 102.

Moreover, the protrusion 212 of the moveable component 104 and the rack structure 206 of the main body 104 couple with each other. The protrusion 212 couples to the tooth space of the rack structure 206. Therefore, the moveable component 104 can be fixed in a position of the main body 102 and not arbitrarily move along the sliding rail 210.

The moveable component 104 moves along the first sliding rail 210 by cooperating with the first sliding rail 210 and the first sliding block 208, thus, the length of the dummy card is changeable. Moreover, the moveable component 104 can be fixed in the fixed position by cooperating between the rack structure 206 and the protrusion 212. Therefore, the length changeable dummy card can adjust the length to correspond to the size differences caused by the appearance of the digital device.

The shortest changing length is controlled by the rack structure of the moveable component 104 in this embodiment. To control the shortest changing length for other application, the space interval between the teeth of the rack structure can be changed in another embodiment.

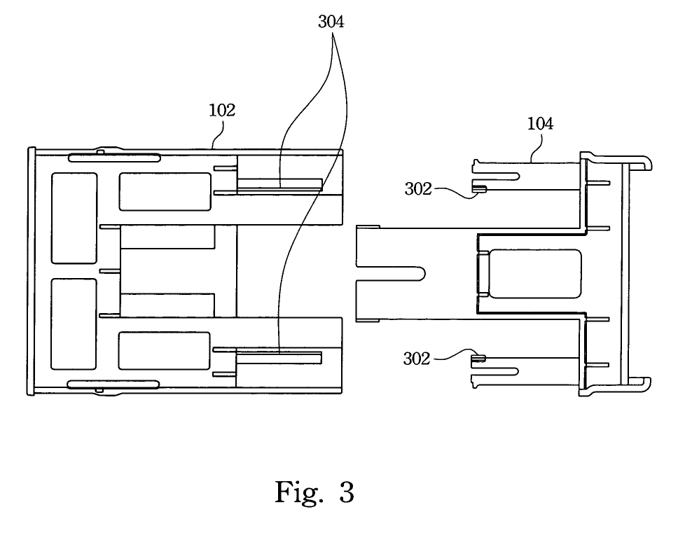

Moreover, the bottom of the length changeable dummy card further comprises a second sliding rail 304 and a second sliding block 302. The second sliding rail 304 is arranged on the main body 102; the second sliding block 302 is arranged on the moveable component 104. FIG. 3 is a bottom decomposition view of the embodiment of the present invention. The position of the second sliding rail 304 and the second sliding block 302 is shown in FIG. 3. The second sliding block 302 corresponds to the second sliding rail 304 of the main body 102. Hence, the second sliding block 302 is slid along the second sliding rail 304.

The dummy card of the embodiment is designed for the PCMCIA slot. Hence, the disposition of the second sliding rail 304 and the second sliding block 302 can enhance the structural strength when the moveable component 104 slides on the main body 102. Some one skilled in the art can apply the embodiment of the invention to a dummy card for other slots by adjust the size and structure of the main body 102 and the moveable component 104. If the dummy card has smaller size in other embodiment, the amount of the sliding rail and the sliding block can be reduced in the allowance of the application.

In view of the foregoing, the variable length dummy card of the embodiment can reduce the resources and costs of the mold and can be used in a wide range of electronic devices regardless of the size of the expansion card slot.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A variable length dummy card comprising:
a main body having a first sliding part; and
a moveable component arranged on a side of the main body, the moveable component having a second sliding part corresponding to the first sliding part for sliding the moveable component on the main body.

2. The dummy card of claim 1, wherein the main body further comprises a first engagement member.

3. The dummy card of claim 2, wherein the moveable component further comprises a second engagement member corresponding to the first engagement member for fixing the moveable component to a position on the main body.

4. The dummy card of claim 3, wherein the second engagement member is a protrusion.

5. The dummy card of claim 2, wherein the first engagement member is a rack structure.

6. The dummy card of claim 1, wherein the first sliding part is a sliding rail structure.

7. The dummy card of claim 1, wherein the second sliding part is a sliding block.

8. A length changeable dummy card comprising:
a fixed component having a first sliding rail; and
a moveable component arranged on the side of the fixed component, the moveable component having a first sliding block corresponding to the first sliding rail for sliding the moveable component on the main body.

9. The dummy card of claim 8, wherein the first sliding rail has a fixed length with no opening to prevent the moveable component separating from the fixed component.

10. The dummy card of claim 8, wherein the fixed component further comprises a first engagement member.

11. The dummy card of claim 10, wherein the first engagement member is a rack structure.

12. The dummy card of claim 10, wherein the moveable component further comprises a second engagement member corresponding to the first engagement member for fixing the moveable component to a position of the fixed component.

13. The dummy card of claim 12, wherein the second engagement member is a protrusion.

14. The dummy card of claim 8, wherein the fixed component further comprises a second sliding rail, the moveable component further comprises a second sliding block corresponding to the second sliding rail for increasing a structural strength when the moveable component sliding on the main body.
